(19) United States
(12) Patent Application Publication
(10) Pub. No.: US 2015/0212742 A1
(43) Pub. Date: Jul. 30, 2015

(54) MEMORY CONTROL DEVICE, INFORMATION PROCESSING APPARATUS, MEMORY CONTROL METHOD, AND, STORAGE MEDIUM STORING MEMORY CONTROL PROGRAM

(71) Applicant: NEC Corporation, Tokyo (JP)

(72) Inventor: Yutaka MATSUZAWA, Tokyo (JP)

(21) Appl. No.: 14/598,837

(22) Filed: Jan. 16, 2015

(30) Foreign Application Priority Data
Jan. 28, 2014 (JP) 2014-013507

(51) Int. Cl. G06F 3/06

(52) U.S. Cl. CPC G06F 3/0614; G06F 3/0658; G06F 3/0673

(57) ABSTRACT

A memory control method comprising: detecting a row address that satisfies a predefined access concentration condition by monitoring a signal for access control of a memory device; and changing correspondence relations between logical addresses and physical addresses (memory mapping) which are used in the access control so as to associate logical addresses corresponding to physical addresses with a detected row address with physical addresses which are distributed to a plurality of row addresses.

This application is based upon and claims the benefit of priority from Japanese Patent Application No. 2014-013507, filed on Jan. 28, 2014, the disclosure of which is incorporated herein in its entirety by reference.

### TECHNICAL FIELD

The present invention relates to a technology to control access to a semiconductor memory in an information processing apparatus.

### BACKGROUND ART

With the increasing miniaturization of a manufacturing process of a semiconductor memory, on a semiconductor memory such as a dynamic random access memory (DRAM), a word line on which access is concentrated gives adjacent word lines electrical influences such as crosstalk or the like. Consequently, a problem in that data corruption occurs on a memory cell connected to the adjacent word line has become significant. To avoid this problem, the following two countermeasures have been taken in general. The first countermeasure is to shorten a refresh cycle. The second countermeasure is to make a memory controller issue a refresh to the adjacent row address which is influenced when access is concentrated.

A technology relevant to the above-described problem is disclosed in PTL1. In the technology of PTL1, when addresses are allocated over a plurality of storage media, an access frequency for each address is monitored to detect an address the access frequency which surpasses a predefined frequency threshold. In the technology of PTL1, the allocation of a storage medium to the detected address is changed to an allocation of another storage medium which is accessible faster than the storage medium which has been allocated.

### CITATION LIST

### Patent Literature

PTL 1: Japanese Patent Application Laid-Open Publication No. 2011-164669

PTL 2: Japanese Patent Application Laid-Open Publication No. 2010-198219

### SUMMARY

### Technical Problem

However, it is conceivable that further miniaturization in the manufacturing process of a semiconductor memory in the future causes more significant influence on adjacent word lines and, accordingly, data corruption becomes more likely to occur. Therefore, there are problems, which will be described below, in the above-described conventional countermeasure and the technology disclosed in PTL1.

In the case of the conventional countermeasure in which a refresh cycle is shortened, further shortening needs to be achieved due to further miniaturization in the manufacturing process. In this case, frequent refresh causes a problem that an increase in the power consumption occurs. Furthermore, because memory access such as reading, writing, and the like is interrupted during refresh is carried out, frequent refresh causes another problem that a decrease in the access performance occurs.

In the case of the conventional countermeasure in which a refresh operation to adjacent row addresses is issued, frequent access concentration to any row address causes frequent refreshes for adjacent row addresses thereof. In consequence, problems such as an increase in the power consumption and a decrease in the access performance are invited.

It is possible to avoid access concentration if a storage medium allocated to an address at which access is concentrated is changed to another storage medium which can provide faster access as described in PTL1. However, PTL1 does not disclose how the access concentration is avoided and a problem of data corruption at adjacent row addresses is avoided when the another storage medium providing faster access cannot be identified.

Accordingly, the present invention is made to solve the above-described problems, and an object of the present invention is to provide a technology that enhances reliability of stored data without inviting an increase in the power consumption and a decrease in the access performance on a semiconductor memory.

### Solution to Problem

A memory control device according to the present invention including: an access control unit configured to control access to a memory device from a host device in accordance with correspondence relations between logical addresses and physical addresses (memory mapping); an access concentration detection unit configured to detect a row address that satisfies a predefined access concentration condition by monitoring a signal from the access control unit to the memory device; and a memory mapping change unit configured to change the memory mapping so as to associate logical addresses corresponding to physical addresses including the row address detected by the access concentration detection unit with physical addresses which are distributed to a plurality of row addresses.

An information processing apparatus according to the present invention including: a memory control device according to claim 1; the memory device; and the host device.

A memory control method according to the present invention including: detecting a row address that satisfies a predefined access concentration condition by monitoring a signal for access control of a memory device; and changing correspondence relations between logical addresses and physical addresses (memory mapping) which are used in the access control so as to associate logical addresses corresponding to physical addresses with a detected row address with physical addresses which are distributed to a plurality of row addresses.

A non-transitory computer readable medium for a memory control program according to the present invention, causing a computer to execute, including: detecting a row address that satisfies a predefined access concentration condition by monitoring a signal for access control of a memory device; and changing correspondence relation between logical addresses and physical addresses (memory mapping) which are used in the access control so as to associate logical addresses corresponding to physical addresses including a detected row address with physical addresses which are distributed to a plurality of row addresses.

### Advantageous Effects of Invention

The present invention provides a technology that enhances reliability of stored data without inviting an increase in the power consumption and a decrease in the access performance on a semiconductor memory.

### BRIEF DESCRIPTION OF THE DRAWINGS

FIG. 1 is a block diagram illustrating a configuration of an information processing apparatus as an exemplary embodiment of the present invention;

FIG. 2 is a hardware configuration diagram of a memory control device of the exemplary embodiment of the present invention;

FIG. 3 is a flowchart illustrating an operation of the memory control device as the exemplary embodiment of the present invention;

FIG. 4 is a diagram illustrating a specific example of memory mapping change of the exemplary embodiment of the present invention; and

FIG. 5 is a diagram illustrating another specific example of the memory mapping change of the exemplary embodiment of the present invention.

### EXEMPLARY EMBODIMENT

An exemplary embodiment of the present invention will be described in detail below with reference to the accompanying drawings.

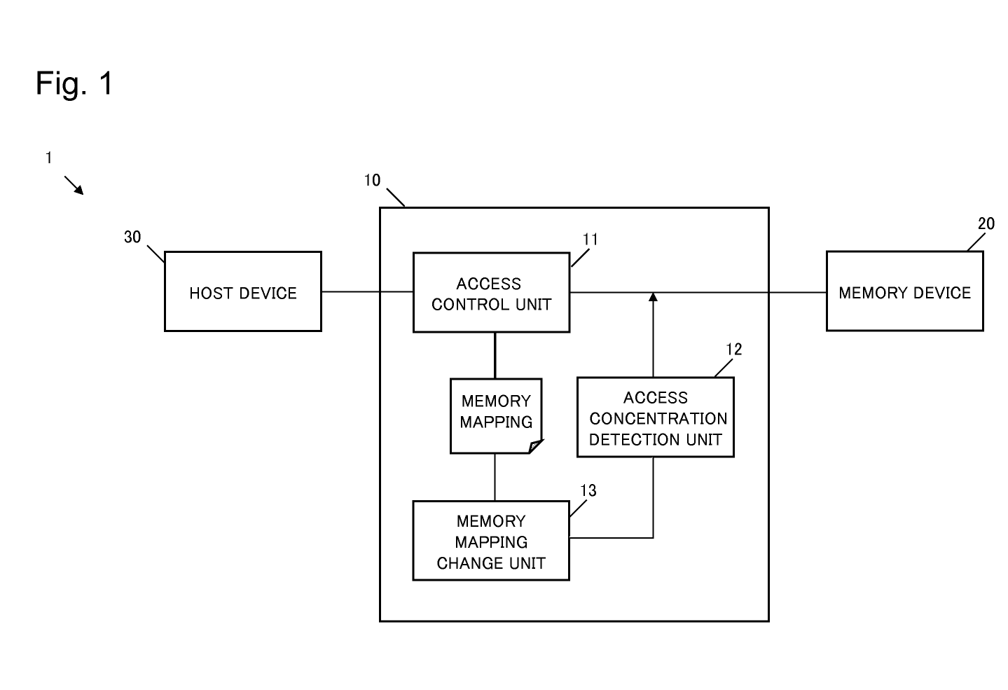

FIG. 1 illustrates a configuration of an information processing apparatus 1 as an exemplary embodiment of the present invention.

In FIG. 1, the information processing apparatus 1 includes a memory control device 10, a memory device 20, and a host device 30. The memory control device 10 includes an access control unit 11, an access concentration detection unit 12, and a memory mapping change unit 13. The host device 30 is configured with a CPU (Central Processing Unit), which controls the general operation of the information processing apparatus 1 while accessing the memory device 20 by using logical addresses. The memory device 20 is, for example, configured with a volatile semiconductor memory such as a DRAM (Random Access Memory) and includes memory cells identified by physical addresses, which are composed of row addresses and column addresses.

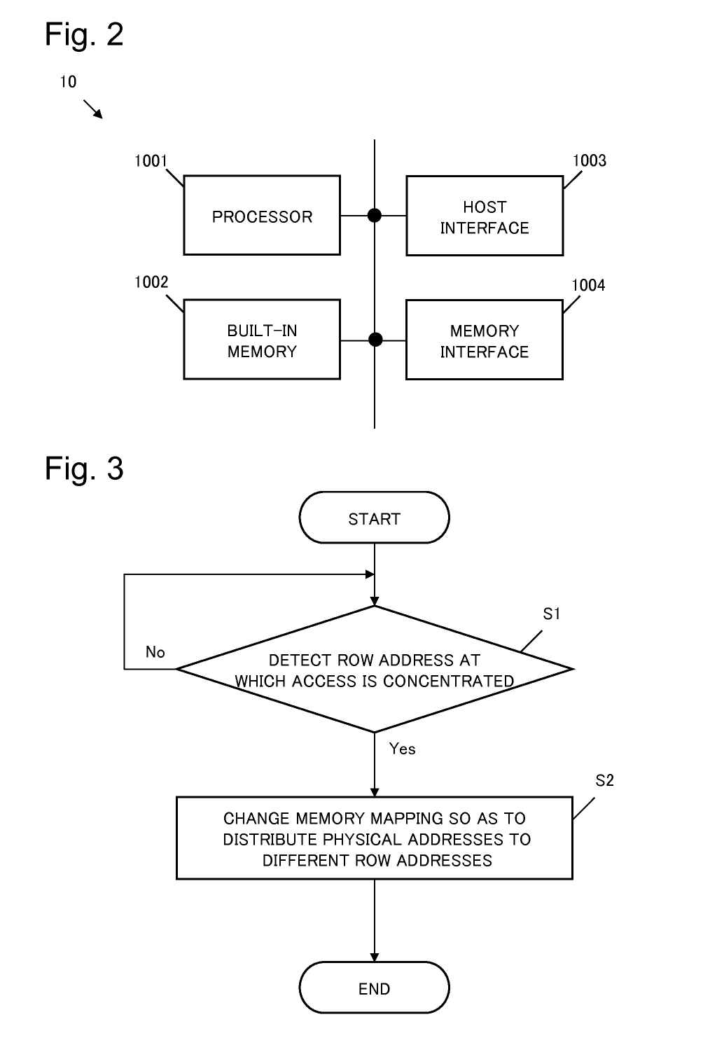

The memory control device 10 is, as illustrated in a hardware configuration diagram in FIG. 2, configurable with a processor 1001, a built-in memory 1002, a host interface 1003, and a memory interface 1004. In this case, the access control unit 11 is configured with the host interface 1003, the memory interface 1004, and the processor 1001 which reads in data and a computer program stored in the built-in memory 1002 and executes the computer program. The access concentration detection unit 12 and the memory mapping change unit 13 are configured with the processor 1001 which reads in data and computer programs stored in the built-in memory 1002 and executes the computer programs. The hardware configuration of the memory control device 10 is not limited to the above-described configuration.

The access control unit 11 controls access to the memory device 20 by referring to correspondence relations between logical addresses and physical addresses (hereinafter referred to as memory mapping). The memory mapping is, for example, is stored in the built-in memory 1002. For example, when the access control unit 11 receives a read instruction to the memory device 20 from the host device 30 via the host interface 1003, the access control unit 11 converts target logical addresses to physical addresses by referring to the memory mapping. The access control unit 11 then transmits a signal indicating a physical address to be read and a signal instructing a read operation to the memory device 20 via the memory interface 1004. The access control unit 11 then receives data stored in the target physical address from the memory device 20 and returns a response to the host device 30. When the access control unit 11, for example, receives a write instruction and target data to the memory device 20 from the host device 30 via the host interface 1003, the access control unit 11 converts target logical addresses to physical addresses by referring to the memory mapping. The access control unit 11 then transmits a signal indicating the physical addresses to be written, a signal instructing a write operation, and the target data to the memory device 20 via the memory interface 1004.

The access concentration detection unit 12, by monitoring a signal from the access control unit 11 to the memory device 20, detects a row address which satisfies a predefined access concentration condition. For example, the access concentration detection unit 12 may count access times for each row address which composes a physical address included in a signal from the access control unit 11 to the memory device 20 and detect a row address the access times value which surpasses a threshold value. Various well-known technologies for detection of a row address at which access is concentrated may also be applied to the access concentration detection unit 12.

The memory mapping change unit 13 changes the memory mapping so as to associate a logical address that corresponds to each physical address with the row address detected by the access concentration detection unit 12 with one of physical addresses which are distributed to a plurality of row addresses.

For example, the memory mapping change unit 13 may change the memory mapping so as to associate a logical address that has been corresponded to a physical address with the detected row address with one of physical addresses with an identical column address. Physical addresses with an identical column address have different row addresses. With such a change, logical addresses which have been associated with a plurality of physical addresses with a row address that access concentration is detected are thus distributed to a plurality of physical addresses with different row addresses.

In order to apply a change of the memory mapping as described above with respect to the row address at which access concentration is detected, it also becomes necessary to change the mapping for a logical address which has been associated with the physical address with which the target logical address is to be associated after the change. Therefore, the memory mapping change unit 13 may change the memory mapping so that, with respect to each row address in the memory mapping, logical addresses associated with physical addresses with the row address are associated with physical addresses with a column address corresponding to the row address. If the number of word lines and the number of bit lines in the memory device 20 are identical, the memory mapping change unit 13 is only necessary to change the memory mapping so as to transpose the row address and the column address of a physical address associated with a logical address.

FIG. 3 illustrates an operation of the memory control device 10 of the information processing apparatus 1 configured as described above.

First, the access concentration detection unit 12 detects a row address which satisfies a predefined access concentration condition (Yes in step S1).

Next, the memory mapping change unit 13 changes the memory mapping so as to associate logical addresses which have been associated with physical addresses with the detected row address with physical addresses which are distributed to a plurality of row addresses (step S2).

The change in the memory mapping in step S2 causes the memory control device 10 to appropriately move data stored in memory cells of physical addresses before the change, which have been associated with the logical addresses the allocation is changed, to memory cells of physical addresses after the change.

This concludes the description of an operation of the information processing apparatus 1.

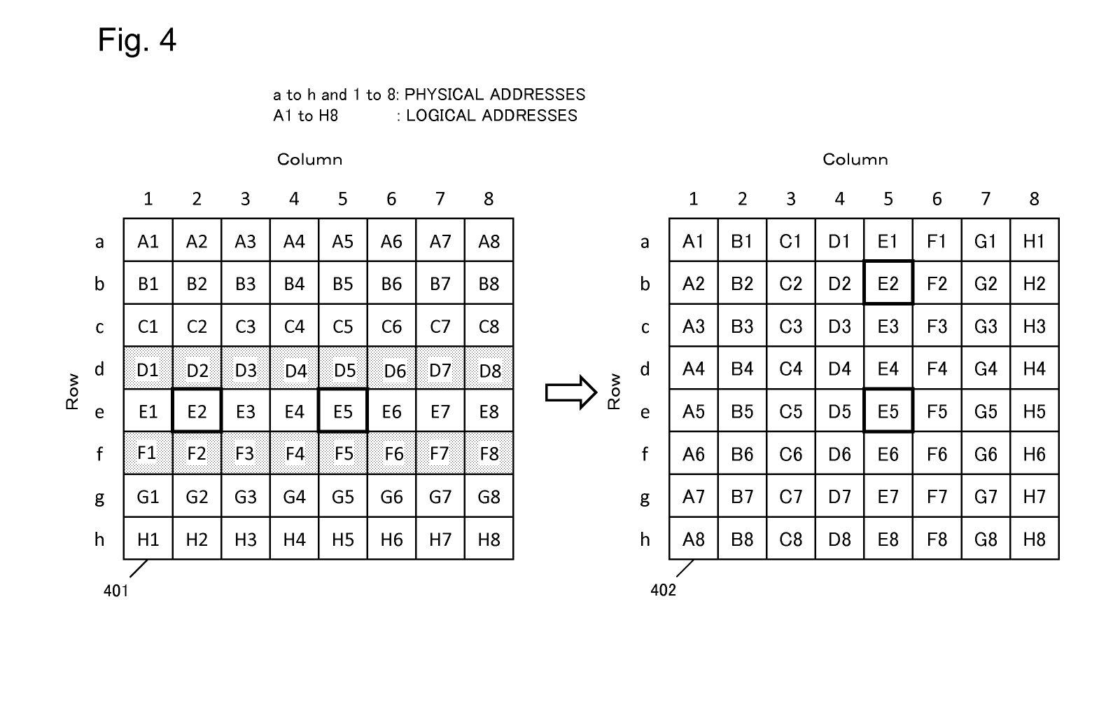

Next, a specific example of change of the memory mapping will be described with reference to FIG. 4. In this specific example, the memory device 20 is assumed to have 8×8 memory cells at the intersections of 8 word lines (row addresses a to h) and 8 bit lines (column addresses 1 to 8). The host device 30 is assumed to use logical addresses A1 to H8.

FIG. 4 illustrates a memory mapping 401 before change and a memory mapping 402 after change. The memory mappings 401 and 402 indicate that a logical address shown in a cell at the intersection of each row of a row address and each column of a column address is associated with a physical address which is composed of the row address and the column address. For example, in the memory mapping 401, a logical address Al is associated with a physical address al that is specified by a row address a and a column address 1.

It is assumed that access is concentrated at logical addresses E2 and E5 when the above-described memory mapping 401 is applied.

The access concentration detection unit 12 thus detects that a row address e satisfies a predefined access concentration condition (step S1).

In this case, there is a possibility that data corruption occurs at row addresses d and f, which are adjacent to the row address e at which access is concentrated.

In this example, because the number of word lines and the number of bit lines are an identical number of 8, the memory mapping change unit 13 carries out a change to interchange a row and a column in the memory mapping (step S2).

Specifically, the memory mapping change unit 13 changes the memory mapping 401 to the memory mapping 402. In other words, in this example, logical addresses which have been associated with physical addresses each of which has one of row addresses a to h in the memory mapping 401 are associated with physical addresses each of which has one of column addresses 1 to 8 in the memory mapping 402. In this manner, the association of logical addresses E1 to E8, which have been associated with the row address e (i.e. physical addresses e1 to e8) at which access concentration is detected, is changed to association with a column address 5 (i.e. physical addresses a5, b5, . . . , h5).

As a result, even if the access concentration at the logical addresses E2 and E5 continues, such access is distributed to the row addresses b and e after the memory mapping 402 is applied. Because of the access distribution, the row addresses b and e become not to satisfy the access concentration condition. With this operation, adjacent row addresses at which data corruption is caused disappear, leading to avoidance of data corruption.

Next, advantageous effects of the exemplary embodiment of the present invention will be described.

The memory control device of the information processing apparatus according to the exemplary embodiment of the present invention makes it possible to enhance the reliability of stored data on a semiconductor memory without causing an increase in the power consumption and a decrease in the access performance.

That is because the access concentration detection unit detects a row address satisfying a predefined access concentration condition by monitoring access a signal to the memory device, and the memory mapping change unit changes the memory mapping so as to associate logical addresses that correspond to physical addresses with the detected row address with physical addresses distributed to a plurality of row addresses.

With this configuration, in the exemplary embodiment, when memory access is concentrated on a specific word line, changing the memory mapping causes the access to be distributed to a plurality of word lines. Although patterns of memory access depend on applications running on the system, even if access is concentrated on whichever word line in whatever patterns of memory access, it is possible to avoid persistent concentrated access to any word line in the exemplary embodiment. In consequence, in the exemplary embodiment, it is possible to suppress influence on adjacent word lines and to enhance the reliability of stored data. Moreover, in the exemplary embodiment, because it is not necessary to carry out a refreshing action more frequently to enhance the reliability of stored data, neither a decrease in the access performance nor an increase in the power consumption is caused.

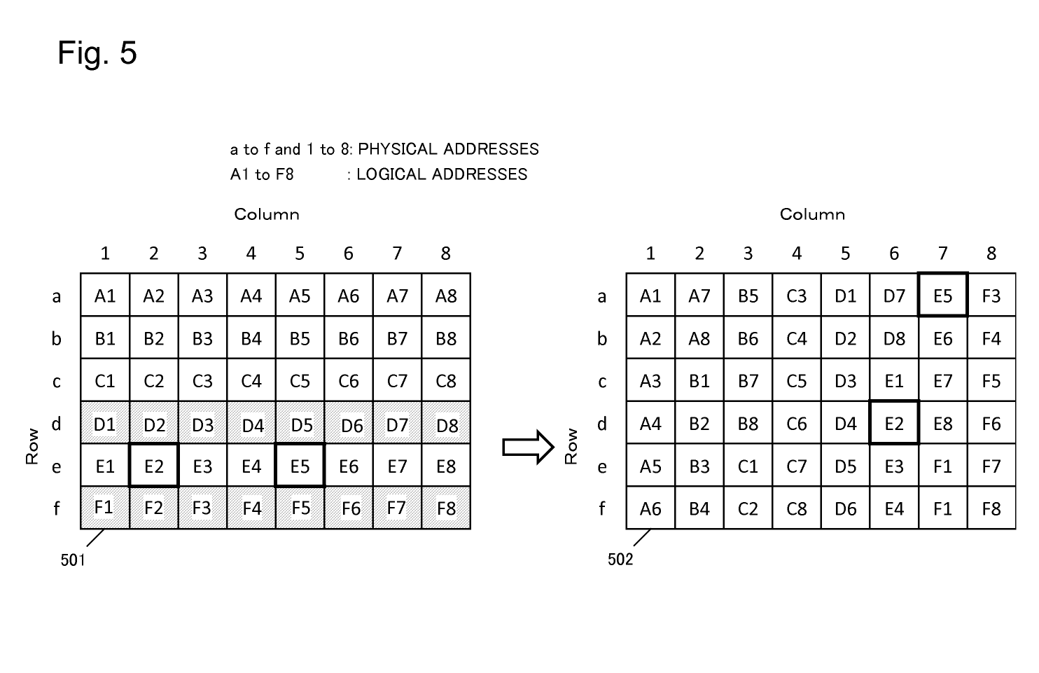

In the above-described exemplary embodiment of the present invention, the memory mapping change unit needs only to distribute logical addresses corresponding to physical addresses with the detected row address to a plurality of row addresses; but do not necessarily have to distribute the logical addresses to completely different row addresses. For example, when the number of word lines and the number of bit lines in the memory device are not identical, the memory mapping change unit may, as illustrated in FIG. 5, change a memory mapping 501 to a memory mapping 502. With such a change, logical addresses corresponding to physical addresses with the row address at which access concentration is detected may be distributed not to completely different row addresses but to a plurality of row addresses. For example, it is assumed that access concentration at logical addresses E2 and E5 causes a detection of a row address e. In this case, by carrying out the change in FIG. 5, access to the logical addresses E2 and ES is distributed to row addresses a and d.

The memory mapping change unit 13 may use, not limited to the above-described method, another method to distribute logical addresses corresponding to physical addresses with a row address at which access concentration is detected to a plurality of row addresses to carry out change of the memory mapping.

Although a case in which DRAMs are used for the memory device was mainly described in the above-described exemplary embodiment of the present invention, components of the memory device is not limited to DRAMs but may be other type of semiconductor memory.

The present invention may be implemented so that the operation of the memory control device, which was described with reference to a flowchart in the above-described exemplary embodiment of the present invention, is recorded in a storage medium as a computer program of the present invention, and a processor reads out and executes the computer program. In such a case, the present invention is configured in a code of the computer program or a storage medium containing the computer program.

The present invention is not limited to the above-described exemplary embodiment but may be realized in various embodiments.

### REFERENCE SIGNS LIST

1 Information processing apparatus

10 Memory control device

20 Memory device

30 Host device

11 Access control unit

12 Access concentration detection unit

13 Memory mapping change unit

1001 Processor

1002 Built-in memory

1003 Host interface

1004 Memory interface

401 and 501 Memory mapping before change

402 and 502 Memory mapping after change

What is claimed is:

1. A memory control device comprising:
an access control unit configured to control access to a memory device from a host device in accordance with correspondence relations between logical addresses and physical addresses (memory mapping);
an access concentration detection unit configured to detect a row address that satisfies a predefined access concentration condition by monitoring a signal from the access control unit to the memory device; and
a memory mapping change unit configured to change the memory mapping so as to associate logical addresses corresponding to physical addresses including the row address detected by the access concentration detection unit with physical addresses which are distributed to a plurality of row addresses.

2. The memory control device according to claim 1,
wherein the memory mapping change unit changes the memory mapping by associating logical addresses corresponding to physical addresses with the row address detected by the access concentration detection unit with physical addresses with an identical column address.

3. The memory control device according to claim 2,
wherein the memory mapping change unit changes the memory mapping by associating, with respect to each row address in the memory mapping, logical addresses corresponding to physical addresses with the row address with physical addresses with a column address corresponding to the row address.

4. An information processing apparatus comprising:
a memory control device according to claim 1;
the memory device; and
the host device.

5. A memory control method comprising:
detecting a row address that satisfies a predefined access concentration condition by monitoring a signal for access control of a memory device; and
changing correspondence relations between logical addresses and physical addresses (memory mapping) which are used in the access control so as to associate logical addresses corresponding to physical addresses with a detected row address with physical addresses which are distributed to a plurality of row addresses.

6. A non-transitory computer readable medium storing a memory control program causing a computer to execute, comprising:
detecting a row address that satisfies a predefined access concentration condition by monitoring a signal for access control of a memory device; and
changing correspondence relation between logical addresses and physical addresses (memory mapping) which are used in the access control so as to associate logical addresses corresponding to physical addresses including a detected row address with physical addresses which are distributed to a plurality of row addresses.
